(19) United States
(12) Patent Application Publication
(10) Pub. No.: US 2012/0064428 A1
(43) Pub. Date: Mar. 15, 2012

(54) SOLID OXIDE FUEL CELL MODULE

(75) Inventors: Jong Sik Yoon, Gyunggi-do (KR); Jae Hyuk Jang, Seoul (KR); Bon Seok Koo, Seoul (KR)

(73) Assignee: SAMSUNG ELECTRO-MECHANICS CO., LTD., Gyunggi-do (KR)

(21) Appl. No.: 13/226,403

(22) Filed: Sep. 6, 2011

(30) Foreign Application Priority Data
Sep. 10, 2010 (KR) 1020100088806

(51) Int. Cl. H01M 8/24; H01M 2/32

(52) U.S. Cl. 429/468

(57) ABSTRACT

Disclosed herein is a solid oxide fuel cell module. The solid oxide fuel cell module according to the present invention includes: a plurality of unit cells each formed by laminating an electrolyte and a cathode in this order on an outer circumferential surface of an anode support formed in a tubular shape; and one or more metal foam connection plates each formed in a plate shape having a predetermined thickness, the metal foam connection plate having grooves formed on one surface thereof in a thickness direction such that the unit cells are respectively received in the grooves. The present invention need not perform a complicated wiring process, unlike the prior art, by employing metal foam connection plates to collect current, thereby simplifying the manufacturing process and reducing the manufacturing costs.

### CROSS REFERENCE TO RELATED APPLICATION

This application claims the benefit of Korean Patent Application No. 10-2010-0088806, filed on Sep. 10, 2010, entitled “Solid Oxide Fuel Cell Module” which is hereby incorporated by reference in its entirety into this application.

### BACKGROUND OF THE INVENTION

1. Technical Field

The present invention relates to a solid oxide fuel cell module.

2. Description of the Related Art

Generally, a fuel cell is a device that directly converts a chemical energy of fuel (hydrogen, LNG, LPG, or the like) and air (oxygen) into electricity and heat by an electrochemical reaction. The fuel cell does not require fuel burning or turbine driving, unlike the existing power generation techniques through the following procedures of fuel burning, vapor generation, turbine driving, power generation driving, and the like. Therefore, the fuel cell is a new concept of power generation techniques that have high efficiency as well as avoid environmental problems. This fuel cell produces little air pollutants such as SO_{X}, NO_{X}, or the like, and generate less carbon dioxide, thereby allowing non-polluting power generation and having merits such as low noise, no vibration, or the like.

The fuel cells come in variety of types, such as a phosphoric acid fuel cell (PAFC), alkaline fuel cell (AFC), a polymer electrolyte membrane fuel cell (PEMFC), a direct methanol fuel cell (DMFC), a solid oxide fuel cell (SOFC), and the like. Among them, the solid oxide fuel cell (SOFC) is suitable for a small-sized or large-sized power station, or a distributed power source, since it enables high-efficiency power generation and allows combined cycle power generation of coal gas, fuel cell, gas turbine, and the like, and has a variety in power generation capacity. Accordingly, the solid oxide fuel cell is an essential power generation technique in order to enter a future hydrogen economy society.

FIG. 1 is a conceptual diagram showing a principle of power generation of a solid oxide fuel cell.

As for a basic principle of power generation of a solid oxide fuel cell (SOFC) with reference to FIG. 1, the following electrode reactions occur at an anode 1 and a cathode 2 when fuel is hydrogen (H₂) or carbon monoxide (CO).

anode: CO+H₂O→H₂+CO₂

2H₂+2O²⁻→4e⁻+2H₂O

cathode: O₂+4e⁻→2O²⁻

overall reaction: H₂+CO+O₂→CO₂+H₂O

That is, electrons (e⁻) generated at the anode 1 are transported to the cathode 2 through an external circuit 4, and simultaneously, oxygen ions (O²⁻) generated at the cathode 2 are transported to the anode 1 through an electrolyte 3. In addition, hydrogen (H₂) is bonded with the oxygen ions (O²⁻) to generate electrons (e) and water (H₂O) at the anode 1. As a result, as for an overall reaction of the solid oxide fuel cell, hydrogen (H₂) or carbon monoxide (CO) is supplied to the anode 1 and oxygen is supplied to the cathode 2, thereby finally generating carbon dioxide (CO₂) and water (H₂O).

The solid oxide fuel cell generating an electric energy through the above-described procedure of power generation has a low overvoltage based on activation polarization and a small irreversible loss. In addition, the solid oxide fuel cell can use hydrogen and hydrocarbon as fuel, thereby offering a wide choice of fuel. Further, the solid oxide fuel cell does not need to use expensive noble metals as an electrode catalyst due to fast reaction rates at the electrodes.

However, a tubular type solid oxide fuel cell among the solid oxide fuel cells has a difficulty in current collection.

FIG. 2 is a perspective view showing a method for current collection of a solid oxide fuel cell according to the prior art. The disadvantages of the prior art with reference to FIG. 2 are as follows.

When current is generated through a power generation procedure of the solid oxide fuel cell, a wire 20 of Ni or Ag needs to wire an outer circumferential surface of a unit cell 10 in order to collect the current. However, a wiring process is complicated, and the wire 20 is very expensive, thus increasing the manufacturing costs. In addition, an increase in a size of the unit cell 10 leads to an increase in a length of the wire 20 for current collection. Therefore, a resistance of the wire 20 is increased, and finally, the efficiency of current collection is decreased. Further, when laminating and stacking a plurality of unit cells 10, every unit cell 10 needs to be subjected to the wiring process. Therefore, the entire system for current collection becomes very complicated.

### SUMMARY OF THE INVENTION

The present invention has been made in an effort to provide a solid oxide fuel cell module capable of increasing the efficiency of current collection as well as achieving stable lamination by employing metal foam connection plates to collect current.

According to a preferred embodiment of the present invention, there is provided a solid oxide fuel cell module including: a plurality of unit cells each formed by laminating an electrolyte and a cathode in this order on an outer circumferential surface of an anode support formed in a tubular shape; and one or more metal foam connection plates each formed in a plate shape having a predetermined thickness, the metal foam connection plate having grooves formed on one surface thereof in a thickness direction such that the unit cells are respectively received in the grooves.

A part of the outer circumferential surface of the anode support may be exposed by removing a part of an outer circumferential surface of the electrolyte and a part of an outer circumferential surface of the cathode, which are protruded further than the metal foam connection plate, in a length direction, and the solid oxide fuel cell module may further include connecting members each provided on the exposed part of the outer circumferential surface of the anode support such that the connecting member is spaced from the cathode, and protruded further than one surface of the metal foam connection plate receiving the unit cells.

The number of metal foam connection plates may be two or more, and the metal foam connection plates and the plurality of unit cells may be alternately laminated such that each of the grooves is selectively contacted with the cathode and the other surface of the metal foam connection plate is selectively contacted with the connecting members.

The metal foam connection plate may include: a first metal foam connection plate disposed at the lowest part, the groove formed on an upper surface of the first metal foam connection plate being selectively contacted with the cathode; and one or more second metal foam connection plates each disposed above the first metal foam connection plate, the groove formed on an upper surface of the second metal foam connection plate being selectively contacted with the cathode and a lower surface of the second metal foam connection plate being selectively contacted with the connecting members, and the solid oxide fuel cell module may further include a metal foam current collection plate formed in a plate shape having a predetermined thickness and disposed above the second metal foam connection plates such that a lower surface of the metal foam current collection plate is selectively contacted with the connecting members.

The groove may have an inner wall formed correspondingly to an outer circumferential surface of the unit cell.

The metal foam connection plate may have porosity.

The metal foam connection plate may be treated with oxidation resistant coating.

The metal foam current collection plate may have porosity.

The metal foam current collection plate may be treated with oxidation resistant coating.

According to another preferred embodiment of the present invention, there is provided a solid oxide fuel cell module including: a plurality of unit cells each formed by laminating an electrolyte and an anode in this order on an outer circumferential surface of a cathode support formed in a tubular shape; and one or more metal foam connection plates each formed in a plate shape having a predetermined thickness, the metal foam connection plate having grooves formed to on one surface thereof in a thickness direction such that the unit cells are respectively received in the grooves.

A part of the outer circumferential surface of the cathode support may be exposed by removing a part of an outer circumferential surface of the electrolyte and a part of an outer circumferential surface of the anode, which are protruded further than the metal foam connection plate, in a length direction, and the solid oxide fuel cell module may further include connecting members each provided on the exposed part of the outer circumferential surface of the cathode support such that the connecting member is spaced from the anode, and protruded further than one surface of the metal foam connection plate receiving the unit cells.

The number of metal foam connection plates may be two or more, and the metal foam connection plates and the plurality of unit cells may be alternately laminated such that each of the grooves is selectively contacted with the anode and the other surface of the metal foam connection plate is selectively contacted with the connecting members.

The metal foam connection plate may include: a first metal foam connection plate disposed at the lowest part, the groove formed on an upper surface of the first metal foam connection plate being selectively contacted with the anode; and one or more second metal foam connection plates each disposed above the first metal foam connection plate, the groove formed on an upper surface of the second metal foam connection plate being selectively contacted with the anode and a lower surface of the second metal foam connection plate being selectively contacted with the connecting members, and the solid oxide fuel cell module may further include a metal foam current collection plate formed in a plate shape having a predetermined thickness and disposed above the second metal foam connection plates such that a lower surface of the metal foam current collection plate is selectively contacted with the connecting members.

The groove may have an inner wall formed correspondingly to an outer circumferential surface of the unit cell.

The metal foam connection plate may have porosity.

The metal foam current collection plate may have porosity.

### BRIEF DESCRIPTION OF THE DRAWINGS

FIG. 1 is a conceptual diagram showing a principle of power generation of a solid oxide fuel cell;

FIG. 2 is a perspective view showing a method for current collection of a solid oxide fuel cell according to the prior art;

FIG. 3 is a perspective view of a single-layer solid oxide fuel cell module according to a preferred embodiment of the present invention;

FIG. 4 is a cross-sectional view of the solid oxide fuel cell module taken along the line A-A′ of FIG. 3;

FIG. 5 is a cross-sectional view of a structure in which solid oxide fuel cell modules shown in FIG. 4 are laminated;

FIG. 6 is a perspective view of a single-layer solid oxide fuel cell module according to another preferred embodiment of the present invention;

FIG. 7 is a cross-sectional view of the solid oxide fuel cell module taken along the line B-B′ of FIG. 6; and

FIG. 8 is a cross-sectional view of a structure in which the solid oxide fuel cell modules shown in FIG. 7 are laminated.

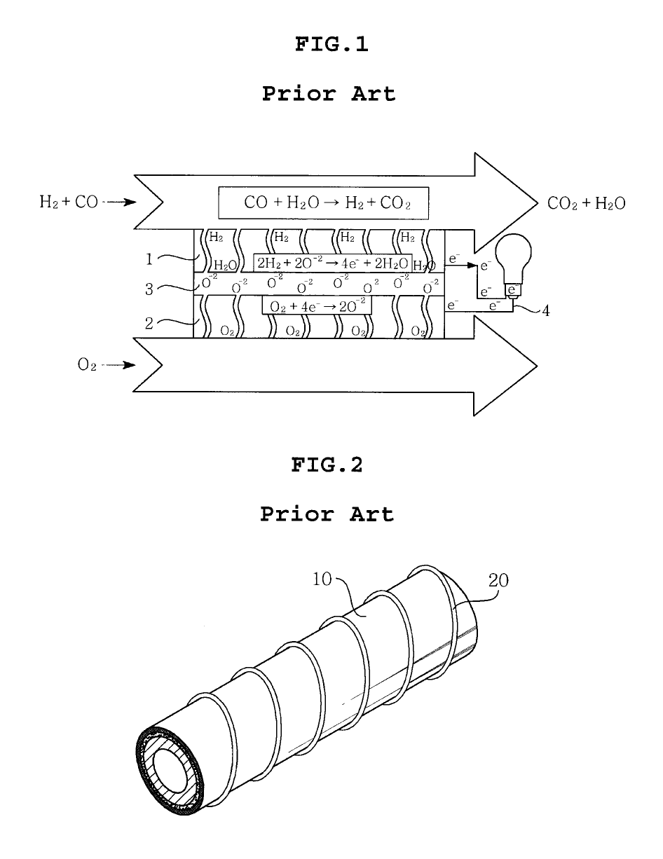

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. Further, when it is determined that the detailed description of the known art related to the present invention may obscure the gist of the present invention, the detailed description thereof will be omitted. Meanwhile, O₂ and H₂ shown in the figures are only for illustrating the operation procedure of a fuel cell in detail, but this does not limit the kind of gases supplied to an anode or a cathode.

Hereinafter, preferred embodiments according to the present invention will be described in detail with reference to the accompanying drawings.

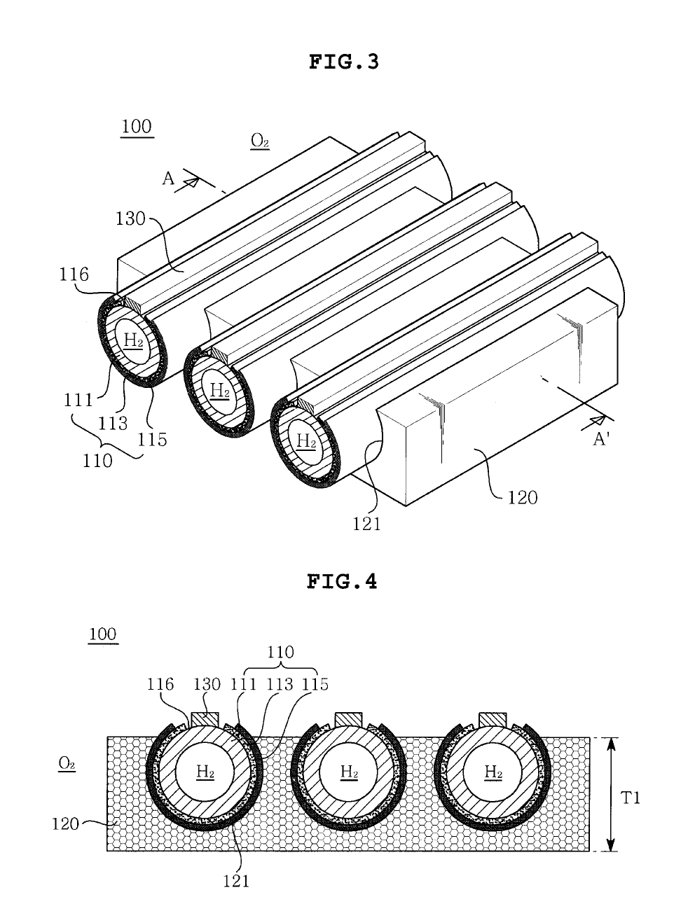

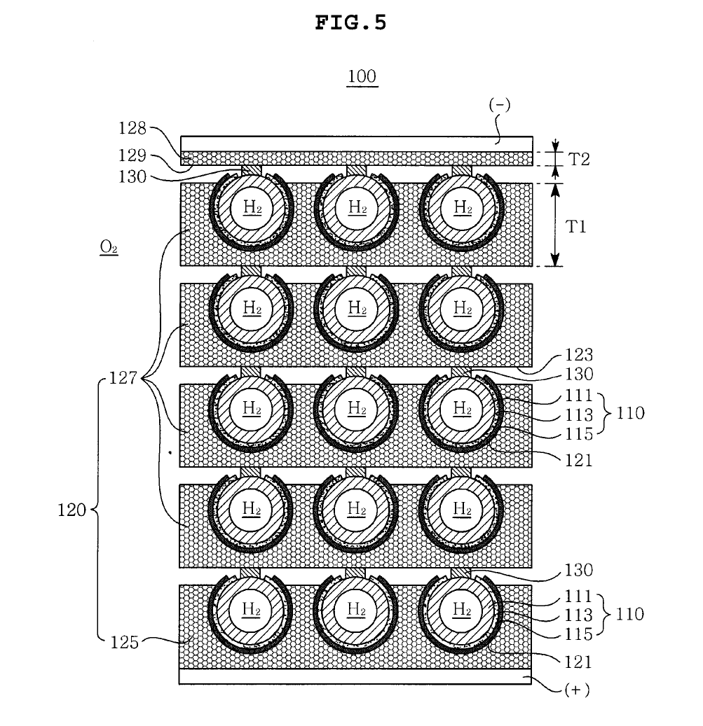

FIG. 3 is a perspective view of a single-layer solid oxide fuel cell module according to a preferred embodiment of the present invention; FIG. 4 is a cross-sectional view of the solid oxide fuel cell module taken along the line A-A′ of FIG. 3; and FIG. 5 is a cross-sectional view of a structure in which the solid oxide fuel cell modules shown in FIG. 4 are laminated.

As shown in FIGS. 3 to 5, a solid oxide fuel cell module 100 according to the present embodiment includes a plurality of unit cells 110 and a metal foam connection plate 120. Each of the unit cells 110 is formed by laminating an electrolyte 113 and a cathode 115 in this order on to an outer circumferential surface of an anode support 111 made in a tubular shape. The metal foam connection plate 120 is formed in a plate shape having a predetermined thickness T1. Grooves 121 are formed on one surface of the meal foam connection plate 120 in a thickness direction such that the unit cells 110 are received in the grooves 121.

The unit cell 110 is a basic unit for generating electric energy, and constituted of the anode support 111, the electrolyte 113, and the cathode 115. The anode support 111, the electrolyte 113, and the cathode 115 constituting the unit cell 110 will be described as follows.

The anode support 111 performs a role of supporting the electrolyte 113 and the cathode 115 laminated on the outer circumferential surface thereof. Therefore, the anode support 111 is, preferably, relatively thicker than the electrolyte 113 and the cathode 115 in order to secure a supporting force. The anode support 111 may be formed through an extruding process. In addition, the anode support 111 is formed in the tubular shape, and receives fuel (hydrogen) from a manifold to generate negative current through an electrode reaction. Herein, the anode support 111 is formed by using nickel oxide (NiO) and yttria stabilized zirconia (YSZ). The nickel oxide is reduced into metallic nickel by hydrogen to express electric conductivity, and the yttria stabilized zirconia expresses ionic conductivity as oxide. Herein, a weight ratio of the nickel oxide and the yttria stabilized zirconia forming the anode support 111 is preferably, for example, 50:50 to 40:60.

The electrolyte 113 performs a role of transporting oxygen ions generated at the cathode 115 to the anode support 111. The electrolyte 113 is laminated and formed on the outer circumferential surface of the anode support 111. Herein, the electrolyte 113 may be formed by coating using a dry method, such as, plasma spray, electrochemical deposition, sputtering, ion beam scan, ion injection, or the like, or a wet method, such as tape casting, spray coating, dip coating, screen printing, doctor blade, or the like, followed by sintering at 1300° C. to 1500° C. Herein, the electrolyte 113 is formed by using yttria stabilized zirconia or Scandium Stabilized Zirconia (ScSZ), GDC, LDC, or the like. As for yttria stabilized zirconia, some of tetravalent zirconium ions are substituted with trivalent yttrium ions. Therefore, one oxygen ion hole per two yttrium ions is generated inside yttria stabilized zirconia, and thus, the oxygen ions move through the hole at high temperature. In the electrolyte 113, ion conductivity is low, and thus a voltage drop due to resistance polarization is small. Therefore, it is preferable to form the electrolyte 113 thinly, if possible. Meanwhile, the pores generated in the electrolyte 113 lead to cause a cross-over phenomenon in which fuel (hydrogen) directly reacts with air (oxygen). This leads to the decrease in efficiency, therefore, care should be taken to prevent the generation of defects.

The cathode 115 receives air (oxygen) from the outside, in which an oxidizing atmosphere is created, to generate positive current through an electrode reaction. The cathode 115 is laminated and formed on the outer circumferential surface of the electrolyte 113. Herein, the cathode 115 may be formed by coating lanthanum strontium manganite ((La_{0.84}Sr_{0.16})MnO₃) or the like having high electron conductivity through a dry method or a wet method, similarly to the electrolyte 113, and then performing a sintering process at 1200° C. to 1300° C. Meanwhile, at the cathode 115, the air (oxygen) is converted to oxygen ions by a catalytic reaction of the lanthanum strontium manganite, and then the oxygen ions are transported to the anode support 111 through the electrolyte 113.

In addition, the solid oxide fuel cell module 100 according to the present preferred embodiment further includes connecting members 130 each transporting the generated negative current from the anode support 111 to the outside of the unit cell 110. Herein, the connecting member 130 is a member for current collection of the anode support 111, and thus, of course, needs to have electric conductivity. In order to form the connecting member 130, first, a part of an outer circumferential surface of the cathode 115 and a part of an outer circumferential surface of the electrolyte 113, which are protruded further than the metal foam connection plate 120, are removed to expose a part 116 of the outer circumferential surface of the anode support 111. Then, the connecting member 130 is disposed on the exposed part 116 of the outer circumferential surface of the anode support 111. Herein, the connecting member 130 needs to be protruded further than one surface of the metal foam connection plate 120 receiving the unit cells 110, so that the connecting member 130 can be connected to the other surface of another metal foam connection plate. The detailed explanation regarding this will be described later. Meanwhile, the connecting member 130 is electrically connected to the anode support 111. Therefore, defects such as shorts are generated when the connecting member 130 is contacted with the cathode 115. Accordingly, it is preferable to space the connecting member 130 from the cathode 115 at a predetermined interval.

The metal foam connection plate 120 performs a role of collecting electric energy generated from the unit cells 110. The metal foam connection plate 120 is formed in a plate shape having a predetermined thickness T1. The metal foam connection plate 120 has grooves 121 formed on one surface thereof in a thickness direction. The unit cells 110 are received in the grooves 121, respectively. Herein, the metal foam connection plate 120 is capable of collecting electric energy generated from the unit cells 110 in parallel due to electric conductivity thereof. Three unit cells 110 are received in one metal foam connection plate 120 in FIGS. 3 and 4, but this is only for illustration. Three or more unit cells 110 or three or less unit cells 110, of course, may be received in the metal foam connection plate 120. An inner wall of the groove 121 is formed in a curved surface correspondingly to the outer circumferential surface of the unit cell 110, thereby maximally increasing the contact area between the metal foam connection plate 120 and the unit cell 110 and thus maximizing the efficiency of current collection. In addition, the metal foam connection plate 120 is formed to have porosity. Therefore, although the unit cell 110 is received in the groove 121 of the metal foam connection plate 120, the air (oxygen) is efficiently supplied to the cathode 115 without any problems. The metal foam connection plate 120 needs to have the above-described electric conductivity and porosity. Therefore, the metal foam connection plate 120 is preferably formed by using metal foam, plate, metal fiber, or the like. Meanwhile, the oxidizing atmosphere is created outside the solid oxide fuel cell module 100 according to the present preferred embodiment. Therefore, it is preferable to perform an oxidation resistant coating treatment on the metal foam connection plate 120 in order to prevent the metal foam connection plate 120 from being oxidized.

As shown in FIGS. 3 and 4, by using one metal foam connection plate 120, current collection can be carried out with respect to the plurality of unit cells 110 in parallel. In addition, as shown in FIG. 5, when using two or more metal foam connection plates 120, the metal foam connection plates 120 and the unit cells 110 may be alternately laminated. When the metal foam connection plates 120 and the unit cells 110 are alternately laminated, the grooves 121 of each of the metal foam connection plates 120 are selectively contacted with only the cathodes 115 of the unit cells 110, respectively, and the other surface of each of the metal foam connection plates 120 is selectively contacted with only the connecting members 130 of the unit cells 110. Therefore, the unit cells 110 received and disposed in parallel in one metal foam connection plate 120 are connected to each other in parallel, and the unit cells 110 received and disposed vertically in different metal foam connection plates 120 are connected to each other in series. As a result, the solid oxide fuel cell module 100 according to the present preferred embodiment is capable of achieving a necessary voltage by regulating the number of metal foam connection plates 120 to be laminated.

A structure in which the metal foam connection plates 120 and the unit cells 110 are alternately laminated will be in detail described with reference to FIG. 5. The metal foam connection plates 120 include a first metal foam connection plate 125, which is disposed at the lowest part, and one or more second metal foam connection plates 127, which are disposed above the first meal foam connection plate 125. A metal foam current collection plate 128 is provided above the second metal foam connection plates 127. The metal foam current collection plate 128 is formed in a plate shape having a predetermined thickness T2. Herein, the grooves 121 formed on an upper surface of the second metal foam connection plate 127 are selectively contacted with only the cathodes 115, and a lower surface 123 of the metal foam connection plate 127 is selectively contacted with only the connecting members 130. Since the unit cells 110 are not disposed below the first metal foam connection plate 125, only the grooves 121 formed on an upper surface of the first metal foam connection plate 125 are selectively contacted with the cathodes 115. Since the unit cells 110 are not disposed above the metal foam current collection plate 128, only a lower surface 129 of the metal foam current collection plate 128 is selectively contacted with the connecting members 130 while the grooves 121 are not formed on an upper surface of the metal foam current collection plate 128, on the contrary to the first metal foam connection plate 125. Therefore, the second metal foam connection plates 127 connect the vertically disposed unit cells 110 in series. In the end, the first metal foam connection plate 125 is capable of collecting positive current and the metal foam current collection plate 128 is capable of collecting negative current. Meanwhile, the metal foam current collection plate 128 is substantially the same as the first metal foam connection plate 125 and the second metal foam connection plate 127, except that the grooves 121 are not formed on the upper surface of the metal foam current collection plate 128. Accordingly, the metal foam current collection plate 128, preferably, has electric conductivity and porosity. Further, the metal foam current collection plate 128 is preferably treated by oxidation resistant coating so that the metal foam current collection plate 128 may avoid being oxidized under the oxidizing atmosphere.

The solid oxide fuel cell module 100 according to the present preferred embodiment employs the metal foam connection plates 120 to collect the current. Therefore, the present preferred embodiment need not perform a complicated wiring process, unlike the prior art, thereby simplifying the manufacturing process and reducing the manufacturing costs. In addition, the present preferred embodiment is capable of stably laminating the plurality of unit cells 110 by using the metal foam connection plates 120, and easily supplying the air (oxygen) to the unit cells 110 due to the porosity of the metal foam connection plates 120.

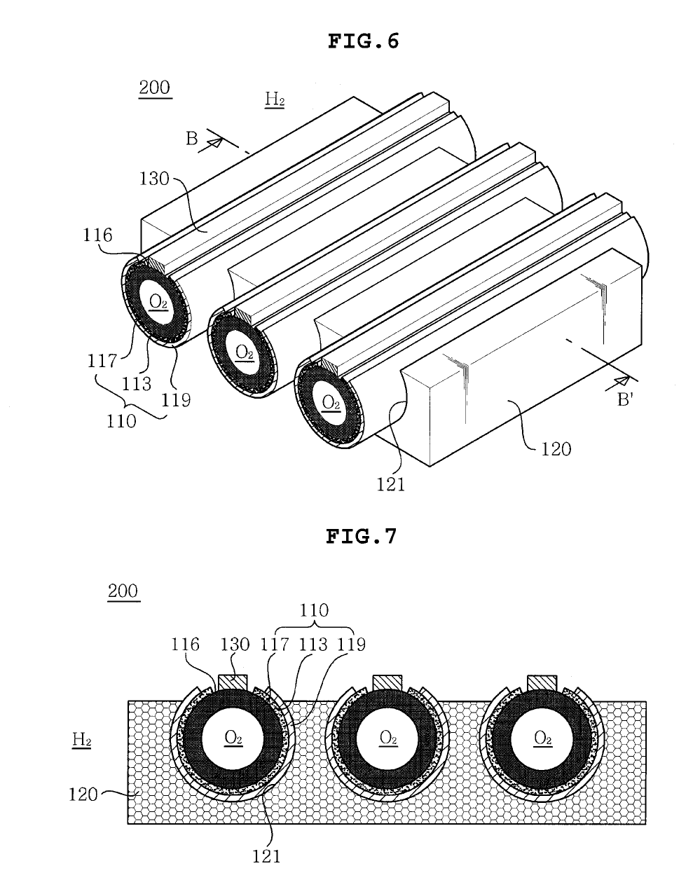

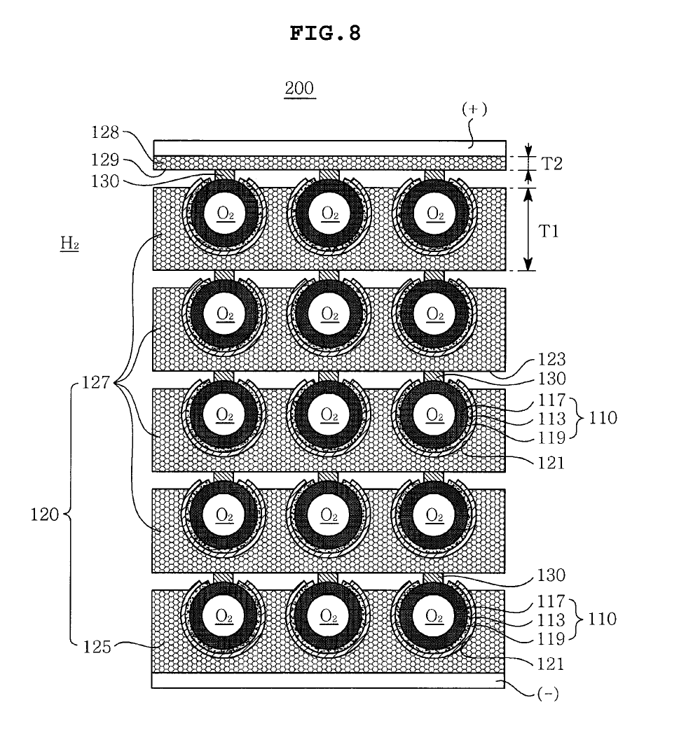

FIG. 6 is a perspective view of a single-layer solid oxide fuel cell module according to another preferred embodiment of the present invention; FIG. 7 is a cross-sectional view of the solid oxide fuel cell module taken along the line B-B′ of FIG. 6; and FIG. 8 is a cross-sectional view of a structure in which solid oxide fuel cell modules shown in FIG. 7 are laminated.

As shown in FIGS. 6 to 9, a solid oxide fuel cell module 200 according to the present preferred embodiment includes a plurality of unit cells 110 and a metal foam connection plate 120. Each of the unit cells 110 is formed by laminating an electrolyte 113 and an anode 119 in this order on an outer circumferential surface of a cathode support 117 made in a tubular shape. The metal foam connection plate 120 is formed in a plate shape having a predetermined thickness. Grooves 121 are formed on one surface of the meal foam connection plate 120 in a thickness direction such that the unit cells 110 are respectively received in the grooves 121.

A large difference between the solid oxide fuel cell module 200 according to the present preferred embodiment and the solid oxide fuel cell module 100 according to the above-described preferred embodiment is in the positions at which anode (anode support) and cathode (cathode support) are formed. Accordingly, the present preferred embodiment will be described based on the difference.

The unit cell 110 is a basic unit for generating an electric energy, and constituted of the cathode support 117, the electrolyte 113, and the anode 119. The cathode support 117, the electrolyte 113, and the anode 119 constituting the unit cell 110 will be described as follows.

The cathode support 117 performs a role of supporting the electrolyte 113 and the anode 119 laminated on the outer circumferential surface thereof. Therefore, the cathode support 117 is, preferably, relatively thicker than the electrolyte 113 and the anode 119 in order to secure a supporting force. The cathode support 117 may be formed through an extruding process. In addition, the cathode support 117 is formed in a tubular shape, and receives air (oxygen) from a manifold to generate positive current through an electrode reaction. Herein, the cathode support 117 may be formed of lanthanum strontium manganite ((L_{0.84}Sr_{0.16})MnO₃) or the like having high electric conductivity. Meanwhile, at the cathode support 117, the air (oxygen) is converted to oxygen ions by a catalytic reaction of the lanthanum strontium manganite, and then the oxygen ions are transported to the anode 119 through the electrolyte 113.

The electrolyte 113 performs a role of transporting oxygen ions generated at the cathode support 117 to the anode 119. The electrolyte 113 is laminated and formed on the outer circumferential surface of the cathode support 117. Herein, the electrolyte 113 may be formed by coating using a dry method, such as, plasma spray, electrochemical deposition, sputtering, ion beam scan, ion injection, or the like, or a wet method, such as, tape casting, spray coating, dip coating, screen printing, doctor blade, or the like, followed by sintering at 1300° C. to 1500° C. Herein, the electrolyte 113 may be formed by using yttria stabilized zirconia or Scandium Stabilized Zirconia (ScSZ), GDC, LDC, or the like. As for yttria stabilized zirconia, some of tetravalent zirconium ions are substituted with trivalent yttrium ions. Therefore, one oxygen ion hole per two yttrium ions is generated inside yttria stabilized zirconia, and thus, the oxygen ions move through the hole at high temperature. In the electrolyte 113, ion conductivity is low, and thus a voltage drop due to resistance polarization is small. Therefore, it is preferable to form the electrolyte 113 thinly, if possible. Meanwhile, the pores generated in the electrolyte 113 cause a cross-over phenomenon in which the air (oxygen) directly reacts with the fuel (hydrogen). This leads to the decrease in efficiency, therefore, care should be taken to prevent the generation of defects.

The anode 119 receives fuel (hydrogen) from the outside, in which a reducing atmosphere is created, to generate negative current through an electrode reaction. The anode 119 is laminated and formed on the outer circumferential surface of the electrolyte 113. Herein, the anode 119 may be formed by coating through a dry method or a wet method, similarly to the electrolyte 113. In addition, the anode 119 is formed by using nickel oxide (NiO) and yttria stabilized zirconia (YSZ). The nickel oxide is reduced into metallic nickel by hydrogen to express electric conductivity, and the yttria stabilized zirconia expresses ionic conductivity as oxide. Herein, a weight ratio of the nickel oxide and the yttria stabilized zirconia forming the anode support 119 is preferably, for example, 50:50 to 40:60.

In addition, the solid oxide fuel cell module 200 according to the present preferred embodiment further includes connecting members 130 each transporting the positive current generated at the cathode support 117 to the outside of the unit cell 110. Herein, the connecting member 130 is a member for current collection of the cathode support 117, and thus, of course, needs to have electric conductivity. In order to form the connecting member 130, first, a part of an outer circumferential surface of the anode 119 and a part of an outer circumferential surface of the electrolyte 113, which are protruded further than the metal foam connection plate 120, are removed to expose a part 116 of the outer circumferential surface of the cathode support 117. Then, the connecting member 130 is disposed on the exposed part 116 of the outer circumferential surface of the cathode support 117. Herein, the connecting member 130 needs to be protruded further than one surface of the metal foam connection plate 120 receiving the unit cells 110, so that the connecting member 130 can be connected to the other surface of another metal foam connection plate. The detailed explanation regarding this will be described later. Meanwhile, the connecting member 130 is electrically connected to the cathode support 117. Therefore, defects such as shorts are generated when the connecting member 130 is contacted with the anode 119. Accordingly, it is preferable to space the connecting member 130 from the anode 119 at a predetermined interval.

The metal foam connection plate 120 performs a role of collecting electric energy generated from the unit cells 110. The metal foam connection plate 120 is formed in a plate shape having a predetermined thickness T1. The metal foam connection plate 120 has grooves 121 formed on one surface thereof in a thickness direction. The unit cells 110 are received in the grooves 121, respectively. Herein, the metal foam connection plate 120 is capable of collecting electric energy generated from the unit cells 110 in parallel due to electric conductivity thereof. Three unit cells 110 are received in one metal foam connection plate 120 in FIG. 6 and FIG. 7, but this is only for illustration. Three or more unit cells 110 or three or less unit cells 110, of course, may be received in the metal foam connection plate 120. An inner wall of the groove 121 is formed in a curved surface correspondingly to the outer circumferential surface of the unit cell 110, thereby maximally increasing the contact area between the metal foam connection plate 120 and the unit cell 110 and thus maximizing the efficiency of current collection. In addition, the metal foam connection plate 120 is formed to have porosity. Therefore, although the unit cell 110 is received in the groove 121 of the metal foam connection plate 120, the fuel (hydrogen) is efficiently supplied to the anode 119 without any problems. The metal foam connection plate 120 needs to have the above-described electric conductivity and porosity. Therefore, the metal foam connection plate 120 is preferably formed by using metal foam, plate, metal fiber, or the like.

As shown in FIGS. 6 and 7, by using one metal foam connection plate 120, current collection can be carried out with respect to the plurality of unit cells 110 in parallel. In addition, as shown in FIG. 8, when using two or more metal foam connection plates 120, the metal foam connection plates 120 and the unit cells 110 may be alternately laminated. When the metal foam connection plates 120 and the unit cells 110 are alternately laminated, the grooves 121 of each of the metal foam connection plates 120 are selectively contacted with only the anodes 119 of the unit cells 110, respectively, and the other surface of each of the metal foam connection plates 120 is selectively contacted with only the connecting members 130 of the unit cells 110. Therefore, the unit cells 110 received and disposed in parallel in one metal foam connection plate 120 are connected to each other in parallel, and the unit cells 110 received and disposed vertically in different metal foam connection plates 120 are connected to each other in series. As a result, the solid oxide fuel cell module 200 according to the present preferred embodiment is capable of achieving a necessary voltage by regulating the number of metal foam connection plates 120 to be laminated.

A structure in which the metal foam connection plates 120 and the unit cells 110 are alternately laminated will be described in detail with reference to FIG. 8. The metal foam connection plates 120 include a first metal foam connection plate 125, which is disposed at the lowest part, and one or more second metal foam connection plates 127, which are disposed above the first metal foam connection plate 125. A metal foam current collection plate 128 is provided above the second metal foam connection plates 127. The metal foam current collection plate 128 is formed in a plate shape having a predetermined thickness T2. Herein, the grooves 121 formed on an upper surface of the second metal foam connection plate 127 are selectively contacted with only the anodes 119, and a lower surface 123 of the metal foam connection plate 127 is selectively contacted with only the connecting members 130. Since the unit cells 110 are not disposed below the first metal foam connection plate 125, only the grooves 121 formed on an upper surface of the first metal foam connection plate 125 are selectively contacted with the anodes 119. Since the unit cells 110 are not disposed above the metal foam current collection plate 128, on the contrary to the first metal foam connection plate 125, only a lower surface 129 of the metal foam current collection plate 128 is selectively contacted with the connecting members 130 while the grooves 121 are not formed on an upper surface of the metal foam current collection plate 128. Therefore, the second metal foam connection plates 127 connect the vertically disposed unit cells 110 in series. In the end, the first metal foam connection plate to 125 is capable of collecting negative current and the metal foam current collection plate 128 is capable of collecting positive current. Meanwhile, the metal foam current collection plate 128 is substantially the same as the first metal foam connection plate 125 and the second metal foam connection plate 127, except that the grooves 121 are not formed on the upper surface of the metal foam current collection plate 128. Accordingly, the metal foam current collection plate 128, preferably, has electric conductivity and porosity.

The solid oxide fuel cell module 200 according to the present preferred embodiment employs the metal foam connection plates 120 to collect the current. Therefore, the present preferred embodiment need not perform a complicated wiring process, unlike the prior art, thereby simplifying the manufacturing process and reducing the manufacturing costs. In addition, the present preferred embodiment is capable of stably laminating the plurality of unit cells 110 by using the metal foam connection plates 120, and easily supplying the fuel (hydrogen) to the unit cells 110 due to the porosity of the metal foam connection plates 120.

As described above, the present invention need not perform a complicated wiring process, unlike the prior art, by employing metal foam connection plates to collect current, thereby simplifying the manufacturing process and reducing the manufacturing costs.

In addition, the present invention is capable of stably laminating a plurality of unit cells by using metal foam connection plates, and easily supplying fuel or air (oxygen) by using porosity of the metal foam connection plates.

Although the preferred embodiments of the present invention have been disclosed for illustrative purposes, they are for specifically explaining the present invention and thus the solid oxide fuel cell module according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A solid oxide fuel cell module, comprising:
a plurality of unit cells each formed by laminating an electrolyte and a cathode in this order on an outer circumferential surface of an anode support formed in a tubular shape; and
one or more metal foam connection plates each formed in a plate shape, having a predetermined thickness, the metal foam connection plate having grooves formed on one surface thereof in a thickness direction such that the unit cells are respectively received in the grooves.

2. The solid oxide fuel cell module as set forth in claim 1, wherein a part of the outer circumferential surface of the anode support is exposed by removing a part of an outer circumferential surface of the electrolyte and a part of an outer circumferential surface of the cathode, which are protruded further than the metal foam connection plate, in a length direction, and
wherein the solid oxide fuel cell module further includes connecting members each provided on the exposed part of the outer circumferential surface of the anode support such that the connecting member is spaced from the cathode, and protruded further than one surface of the metal foam connection plate receiving the unit cells.

3. The solid oxide fuel cell module as set forth in claim 2, wherein the number of metal foam connection plates is two or more, and the metal foam connection plates and the plurality of unit cells are alternately laminated such that each of the grooves is selectively contacted with the cathode and the other surface of the metal foam connection plate is selectively contacted with the connecting members.

4. The solid oxide fuel cell module as set forth in claim 3, wherein the metal foam connection plate includes:
a first metal foam connection plate disposed at the lowest part, the groove formed on an upper surface of the first metal foam connection plate being selectively contacted with the cathode; and
one or more second metal foam connection plates each disposed above the first metal foam connection plate, the groove formed on an upper surface of the second metal foam connection plate being selectively contacted with the cathode and a lower surface of the second metal foam connection plate being selectively contacted with the connecting members, and
wherein the solid oxide fuel cell module further includes a metal foam current collection plate formed in a plate shape, having a predetermined thickness, and disposed above the second metal foam connection plates such that a lower surface of the metal foam current collection plate is selectively contacted with the connecting members.

5. The solid oxide fuel cell module as set forth in claim 1, wherein the groove has an inner wall formed correspondingly to an outer circumferential surface of the unit cell.

6. The solid oxide fuel cell module as set forth in claim 1, wherein the metal foam connection plate has porosity.

7. The solid oxide fuel cell module as set forth in claim 1, wherein the metal foam connection plate is treated with oxidation resistant coating.

8. The solid oxide fuel cell module as set forth in claim 4, wherein the metal foam current collection plate has porosity.

9. The solid oxide fuel cell module as set forth in claim 4, wherein the metal foam current collection plate is treated with oxidation resistant coating.

10. A solid oxide fuel cell module, comprising:
a plurality of unit cells each formed by laminating an electrolyte and an anode in this order on an outer circumferential surface of a cathode support formed in a tubular shape; and
one or more metal foam connection plates each formed in a plate shape having a predetermined thickness, the metal foam connection plate having grooves formed on one surface thereof in a thickness direction such that the unit cells are respectively received in the grooves.

11. The solid oxide fuel cell module as set forth in claim 10, wherein a part of the outer circumferential surface of the cathode support is exposed by removing a part of an outer circumferential surface of the electrolyte and a part of an outer circumferential surface of the anode, which are protruded further than the metal foam connection plate, in a length direction, and
wherein the solid oxide fuel cell module further includes connecting members each provided on the exposed part of the outer circumferential surface of the cathode support such that the connecting member is spaced from the anode, and protruded further than one surface of the metal foam connection plate receiving the unit cells.

12. The solid oxide fuel cell module as set forth in claim 11, wherein the number of metal foam connection plates is two or more, and the metal foam connection plates and the plurality of unit cells are alternately laminated such that each of the grooves is selectively contacted with the anode and the other surface of the metal foam connection plate is selectively contacted with the connecting members.

13. The solid oxide fuel cell module as set forth in claim 12, wherein the metal foam connection plate includes:
a first metal foam connection plate disposed at the lowest part, the groove formed on an upper surface of the first metal foam connection plate being selectively contacted with the anode; and
one or more second metal foam connection plates each disposed above the first metal foam connection plate, the groove formed on an upper surface of the second metal foam connection plate being selectively contacted with the anode and a lower surface of the second metal foam connection plate being selectively contacted with the connecting members, and
wherein the solid oxide fuel cell module further includes a metal foam current collection plate formed in a plate shape having a predetermined thickness and disposed above the second metal foam connection plates such that a lower surface of the metal foam current collection plate is selectively contacted with the connecting members.

14. The solid oxide fuel cell module as set forth in claim 10, wherein the groove has an inner wall formed correspondingly to an outer circumferential surface of the unit cell.

15. The solid oxide fuel cell module as set forth in claim 10, wherein the metal foam connection plate has porosity.

16. The solid oxide fuel cell module as set forth in claim 13, wherein the metal foam current collection plate has porosity.
